(19) United States
(12) Patent Application Publication
(10) Pub. No.: US 2025/0078199 A1
(43) Pub. Date: Mar. 6, 2025

(54) Unified Memory GPU with Localized Mode

(71) Applicant: NVIDIA Corporation, Santa Clara, CA (US)

(72) Inventors: Wish GANDHI, Sunnyvale, CA (US); Ze LONG, San Jose, CA (US); Kun FANG, San Jose, CA (US)

(21) Appl. No.: 18/239,733

(22) Filed: Aug. 29, 2023

(51) Int. Cl. G06T 1/60

(52) U.S. Cl. CPC G06T 1/60

(57) ABSTRACT

A GPU can selectively confine software function execution and associated data storage resources to locally-connected processing/storage components, thereby minimizing latency and other overhead that would otherwise be needed to access more remote resources. The GPU can selectively permit other software function execution and associated data storage resources to range across non-locally-connected processing/storage components when more processing and/or storage resources are required.

### CROSS-REFERENCE TO RELATED APPLICATIONS

None.

### FIELD

The technology herein relates to graphics processing units (GPUs) and to memory access techniques within multi-GPU systems. More particularly, the technology herein relates to a GPU based system of the type that uses unified memory addressing to enable multiple processing cores to have a common unified view into memory and access each other's locally connected memory, including address mapping hardware that selectively restricts the scope of a processing core's memory access to memory that is locally connected to the processing core. The technology herein further includes application programming interface calls to localize memory access.

### BACKGROUND & SUMMARY

Modern high performance computing systems provide high degrees of parallel execution in both a multi-core central processing unit (CPU) and in one or more graphics processing units (GPUs) the CPU supervises and controls.

Modern high performance GPUs comprise hundreds or thousands of processing cores—each of which may be a heavily multithreaded, in-order, SIMD (single instruction, multiple-data)—processor that shares its control and instruction cache with other cores.

Such shared GPU hardware subsets—which are sometimes called “Graphics Processing Clusters” or GPCs—comprise the dominant high-level hardware block of many GPUs. In some designs, each GPC includes a dedicated Raster Engine, plural raster operation partitions (“ROPs”) (each partition containing a number of ROP units), a number of “streaming multiprocessors” (“SMs”) and one or more PolyMorph Engines. Each SM in turn may contain many processing cores, some number of Tensor Cores, a Register File, some number of Texture Units, a Ray Tracing Core, and L1/Shared Memory which can be configured for differing capacities depending on the needs of the compute or graphics workloads. Each GPC also needs to be able to access memory so it can store and retrieve data needed for its tasks. The GPCs are the basic functional processing building blocks of the GPU.

More and more GPCs can be packed into the same GPU to increase parallelism-but providing each GPC with high speed memory access can be a challenge. As graphics processing units (GPUs) scale, a fully connected “crossbar” (xbar) between each GPC and the memory subsystem would be too costly to build. NVIDIA has instead structured some GPUs so that multiple GPCs form a “micro GPU” (uGPU). Each uGPU comprises GPCs and on-chip “L2” (level 2) cache memory connected together using a crossbar. These fully connected uGPU clusters are then connected together using L2 network-on-chip (“NOC”) or chip-to-chip (“C2C”) connections to form a big GPU. See FIGS. 1 & 1A and e.g., U.S. Pat. No. 10,915,445.

FIG. 2 shows each GPC comprising a number (e.g., 8) of SMs as described above. In the FIG. 2 example, each uGPU comprises a number (e.g., four) GPCs connected by a memory management unit (MMU) to a “crossbar”. The GPCs use the crossbar to access stacks of high bandwidth memory (“HBM”) comprising dynamic random access memory (DRAM) chips forming the GPU's memory subsystem. See e.g., U.S. Pat. No. 11,663,036. The crossbars also provide a high speed communications interface that permits the uGPUs to communicate with one another. The crossbars provide a communications path between each uGPU and an “NVLINK” NOC communications interface that enables the GPU to communicate with other GPUs that in turn are composed of uGPUs comprising GPCs. Thus, each uGPU is able to communicate with any other uGPU in the system and each GPC is able to access the memory of any other GPC—offering tremendous flexibility in terms of parallelism, processing coordination and data sharing.

Such flexibility is consistent with the unified virtual addressing shown in FIG. 3. Such unified virtual addressing has long been provided in NVIDIA platforms in which all processors see a single coherent memory image with a common address space. See e.g., CUDA Programming Guide v12.1 Section 19 (“Unified Memory Programming”), which explains:
Unified Memory is a component of the CUDA programming model . . . that defines a managed memory space in which all processors see a single coherent memory image with a common address space. A processor refers to any independent execution unit with a dedicated MMU. This includes both CPUs and GPUs of any type and architecture. The underlying system manages data access and locality within a CUDA program without need for explicit memory copy calls. This benefits GPU programming in two primary ways: GPU programming is simplified by unifying memory spaces coherently across all GPUs and CPUs in the system and by providing tighter and more straightforward language integration for CUDA programmers. Data access speed is maximized by transparently migrating data towards the processor using it.

For example, FIG. 4 shows how GPU0 (or a uGPU within GPU0) in such an architecture accesses (loads from/stores to) memory allocated to GPU1 (or a uGPU within GPU1) through peer-to-peer (P2P) communication between GPU0 and GPU1. Similarly, the CPU shown in FIGS. 3 & 4 is able to address memory allocated to any GPU because all such memories are within the unified virtual memory address space of the CPU.

Meanwhile, NVIDIA has previously used processor affinity masks to control what graphics rendering work is assigned to what GPU in such a multi-GPU system. Such processor affinity masks have been used to enable an application to determine which graphics processing unit(s) are most appropriate for processing graphics rendering work associated with a current rendering context. See e.g., U.S. Pat. No. 8,253,749 entitled “Using Affinity Masks To Control Multi-GPU Processing”; see also//registry.khronos.org/OpenGL/extensions/NV/WGL_NV_gpu_affinity.txt (NVIDIA 2005-2006).

As noted above, the crossbars shown in FIG. 2 give each GPC in each uGPU cluster within each GPU important/needed access to the device memory via a last level cache (LTC). Any GPC location is able to access any memory location in the entire GPU (i.e., the memory allocated to the clusters is viewed as a single memory).

Each GPC has full bandwidth access to its own local (level 1) cache, so when a GPC accesses its own local memory, the access will be faster. Memory accesses that go from one cluster (uGPU) to another will get only reduced (e.g., half) bandwidth as compared to GPC access to its own local cache. This is because the access path is indirect (i.e., it may need to go across an NVLINK NOC connection) when a GPC in one cluster wants to access data in another cluster (uGPU)-which increases latency. Furthermore, because on-chip communications are generally faster than communications between chips, the latency problem gets worse when the memory access uses a chip-to-chip (C2C) communication link between GPUs on different dies.

Moreover, in some implementations, each cluster (uGPU) keeps a copy of the accessed data in its own local cache, generating two cached copies. To be more specific, if a GPC in one cluster wishes to access the data stored in memory allocated to another cluster, the requesting GPC sends a request to the crossbar and into the GPC's local level 2 cache. The local cache will forward the request through the NOC connection to the crossbar and on to the cache of the other cluster. The cache of the other cluster is responsible for fetching the requested data from its memory and sending it back. The other cluster keeps a copy of the data in its local cache and forwards the data to the original requesting cluster. The requesting cluster will keep a second copy of the data in its own cache and return the data to the requesting GPC. One can see that a GPC accessing data in a remote cluster causes the GPU to store two copies of the data, thereby decreasing memory utilization efficiency, consuming more energy (e.g., by sending commands and data across a network connection), and increasing latency. In other words, fetching data from the fully connected GPU memory system in the FIG. 2 architecture is low latency, but getting data from remote memory is high latency and may also cause data duplication in the last level cache (“LTC”).

What is needed is a way to preserve the flexibility and power of the unified virtual memory addressing approach while minimizing latency, current draw and data storage overhead incurred when a uGPU accesses memory allocated to another uGPU.

### BRIEF DESCRIPTION OF THE DRAWINGS

FIGS. 1 & 1A are block diagrams of a prior art GPU architecture providing inter-GPU communications.

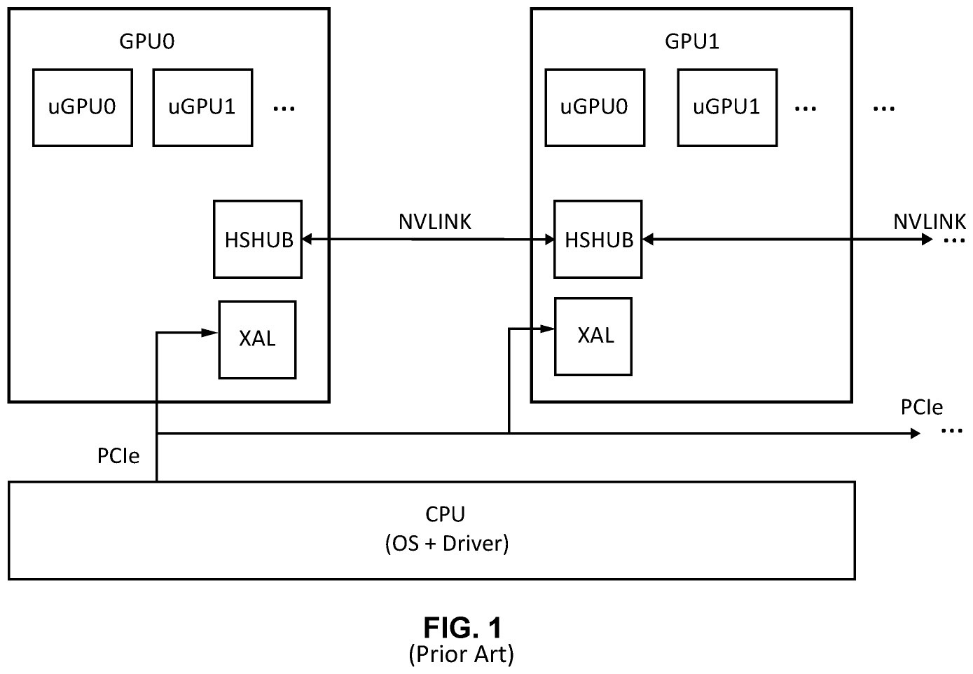

FIG. 2 is a block diagram of a prior art GPU architecture.

FIG. 3 is a block diagram showing prior art unified virtual addressing within a processing system including multiple GPUs.

FIG. 4 is a block diagram showing direct access peer-to-peer communication between GPUs.

FIG. 5 is a block diagram of a GPU architecture spanning multiple dice.

FIG. 6A schematically shows an operating mode with an application and associated data storage spread across plural micro GPUs.

FIG. 6B schematically shows an operating mode with an application divided into different parts that are confined to respective micro GPUs and associated local memory.

FIG. 7 is a flowchart of an example process performed by an application to create the FIG. 6B scenario.

FIG. 8 shows an example hardware and software GPU control structure.

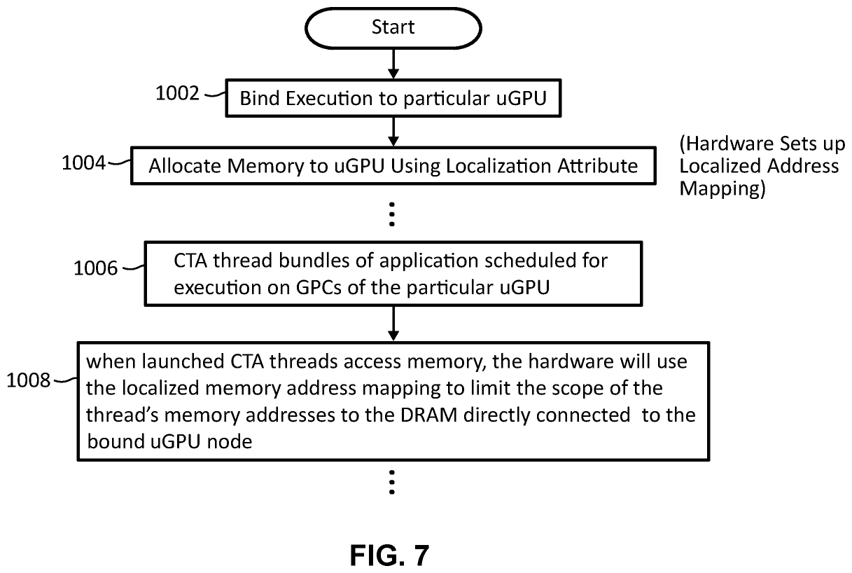

FIG. 9A shows memory allocation with localization mode=0.

FIG. 9B shows memory allocation with localization mode=1.

### DETAILED DESCRIPTION OF NON-LIMITING EMBODIMENTS

The technology herein solves problems relating to such high latency remote memory accesses. Example solutions provide new functionality in both hardware and software.

In one embodiment, upon receiving an appropriate request from an application, the GPU can selectively confine software function execution and associated data storage resources to locally-connected processing/storage components, thereby minimizing latency and other overhead that would otherwise be needed to access more remote resources. Meanwhile, the GPU can selectively permit other software function execution and associated data storage resources to range across remotely-connected processing/storage components of a unified virtual memory accessing approach e.g., when more processing and/or storage resources are needed.

In one embodiment, hardware selectively localizes both the compute and the associated data to one die and in particular to a single processing cluster on that die.

In one embodiment, the hardware leverages NVIDIA's GPC affinity mask feature described above to allow the software application to allocate compute programs to one or a selected group of GPCs. For example, the GPC affinity mask can be used to constrain execution of particular compute operations to a particular set of GPCs within a particular uGPU. An application programming interface (“API”) built into the CUDA device memory allocation command (“cudamalloc”) uses such GPC affinity masks to assign compute workloads to GPCs belonging to a given uGPU.

In conjunction with the use of affinity masks to localize execution, example embodiments additionally provide, in combination, a memory localization feature. Specifically, in one embodiment, the software application is able to specify a localization attribute each time it allocates memory. This attribute can specify whether to use localized memory mapping or not. Once the GPU Resource Manager (RM) receives the attribute specifying localization, the RM sends a flag into the GPU memory system that programs the GPU memory system so that when it sees a memory translation with that flag, it will perform (re)mapping into localized memory instead of the typical stride-based non-localized memory mapping across the unified GPU memory system.

In one embodiment, with the help of RM and address mapping, the GPU architecture selectively allocates data into the memory devices belonging to the same uGPU. When the application program wants to access data and localization mode is activated, it will access only its local memory connected through the full xbar and avoid hopping into the remote memory systems (e.g., in another uGPU), eliminating the need to access remote memory with associated high latency. This memory localization is a little like the children of a large family (who are each allowed to play in any of the backyards of the neighborhood) all choosing to play in their own backyard when dinnertime rolls around so they are not late for dinner.

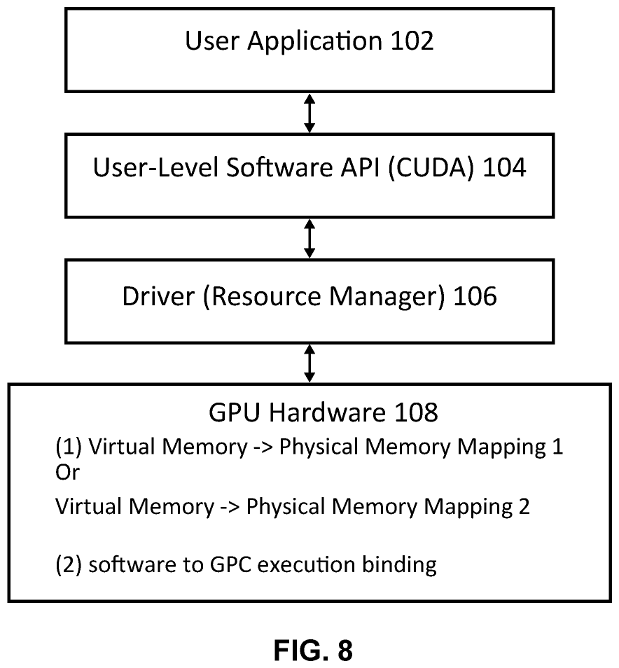

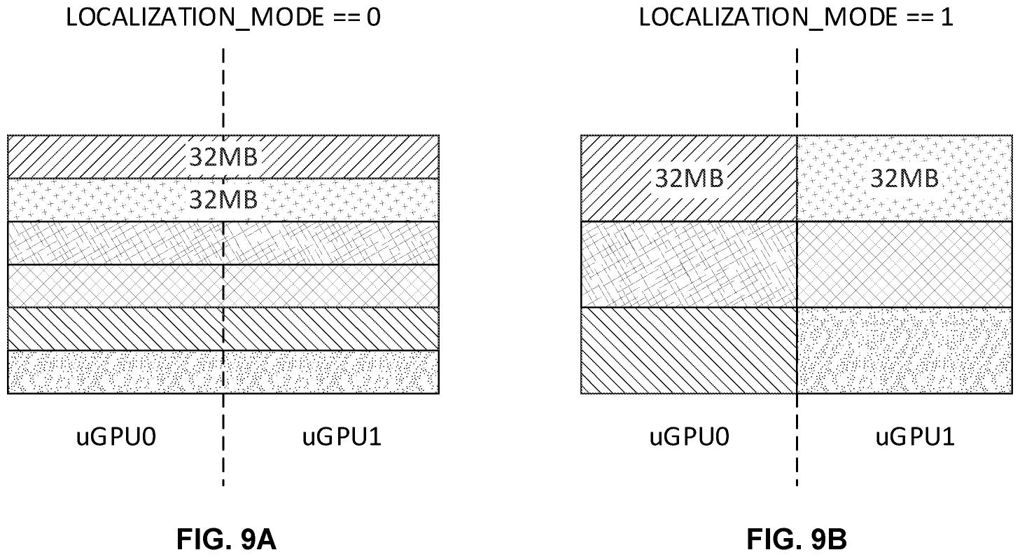

In one embodiment, hardware is used to localize compute and data to one cluster. An affinity mask as noted above is used to confine operations within the particular uGPU. The software specifies an attribute that indicates which cluster. A flag sent into the GPU memory system will cause localized mapping instead of the default memory usage to stride across plural DRAM memory devices. The GPU hardware will do a virtual to physical mapping to assign a first (e.g., 32 MB) allocation to a first cluster, a second (e.g., 32 MB) allocation to the next cluster, and so on. An associated API to use this memory localization function (cudamalloc=memory localization) may be exposed to the programmer/developer so the developer can specify that a certain amount of physical memory on uGPUn should be mapped using localized mapping. The RM in response to the allocation, then performs a physical megabyte virtual to physical mapping on the GPU—resulting in a localized allocation such as shown in FIG. 9B. This localized memory mapping function complements the existing API call to use the affinity mask to map particular software functions onto a particular subset of GPCs. The two types of API calls together can ensure localization of particular memory used by particular functions executing on particular GPCs within the GPU.

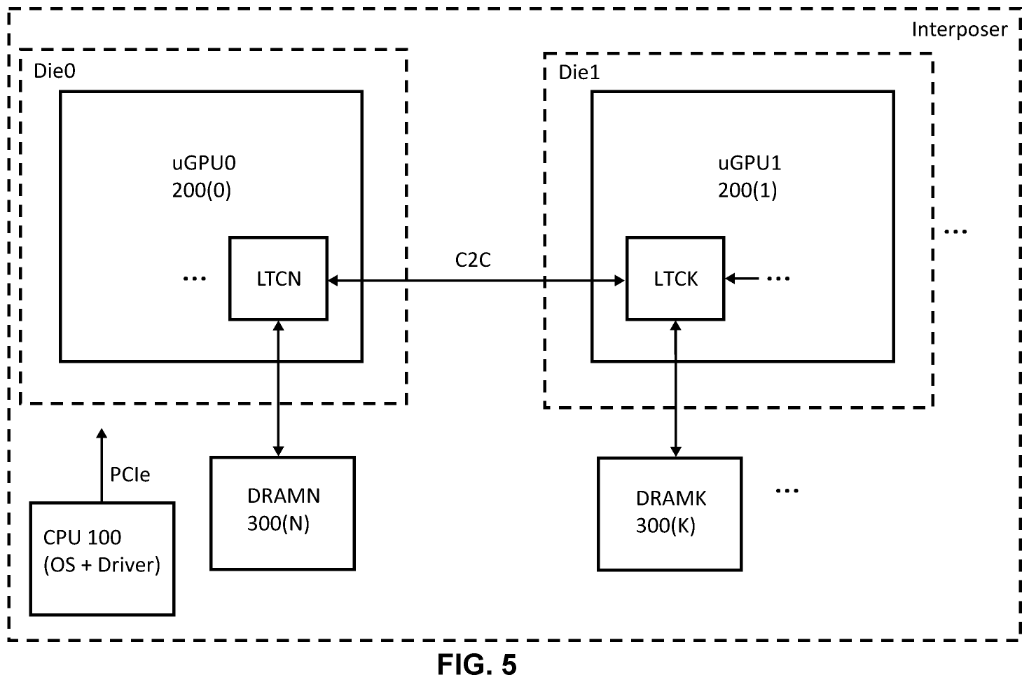

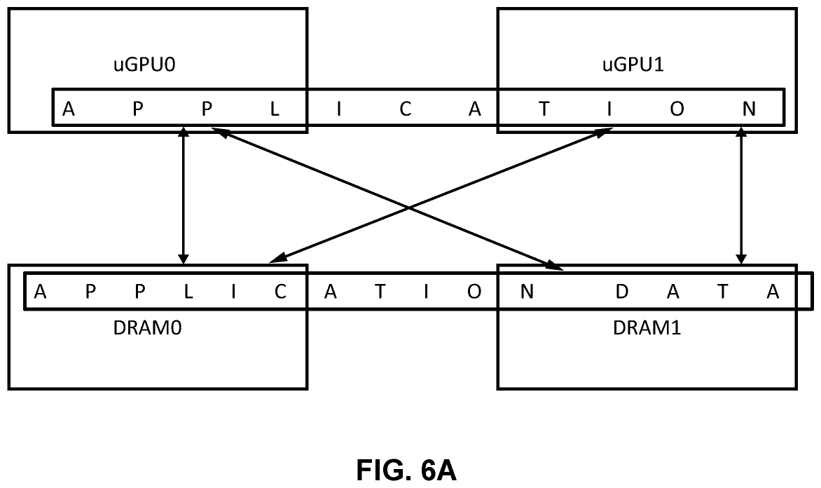

FIG. 6A shows an example GPU comprising two uGPU clusters each directly connected to a respective DRAM memory via a respective fully connected crossbar, but each having the capability of accessing the other uGPU's directly connected memory. In the example shown, the GPU can schedule some threads of an application to execute on uGPU0 and it can schedule other threads of the application to execute on uGPU1. Each thread has a full view of the GPU memory system including DRAM0 and DRAM 1—and each thread can thus read from and write to each DRAM. There are application software scenarios in which it is advantageous for the GPU to support such parallel execution across multiple uGPUs and memory access across multiple DRAMs.

However, as one example use case of the memory localization feature described herein, as shown in FIG. 6B, a programmer can instead decide to divide the application program into two parts: one part for execution solely on uGPU0 and another part for execution solely on uGPU1. The programmer can then use the API calls described above to bind execution of the first part to uGPU0 and execution of the second part to uGPU1; and further to localize the memory of each uGPU so the first part accesses only the DRAM memory local to uGPU0 and does not access the memory local to uGPU1 (and similarly so the second part accesses only the DRAM memory local to uGPU1 and does not access the memory local to uGPU0). In one embodiment, each “part” can comprise a CTA, a thread block, a warp, a function, or any other desired unit of execution. The parallel execution of the first and second parts of the program on uGPU0 and uGPU1 respectively will proceed efficiently with low memory latency in each case and without either part intruding into the other part's local memory. Rather, through selective memory mapping and execution scheduling, the GPU hardware ensures that the first part of the application is confined (as indicated schematically by the picket fence) to uGPU0 and associated storage in DRAM0; and the second part of the application is confined to uGPU1 and associated storage in DRAM1. This selectively-activated, hardware-imposed temporary and programmable constraint on more flexible hardware capabilities of providing the resource sharing of FIG. 6A can be advantageous in a number of particular circumstances-especially where uGPU0 and uGPU1 are on different semiconductor dies. The GPU provides this constraint through an ability to have a unified view into both DRAMs and to centrally manage both DRAMs and through utilizing flexible communication and messaging across the GPU.

### More Detailed Description

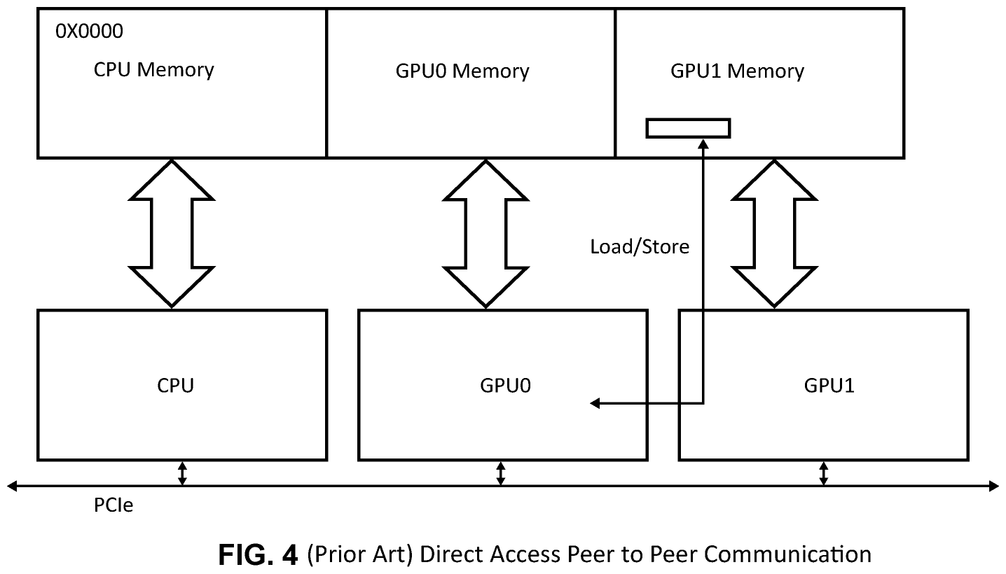

One example GPU chip implementation is built upon the concept of the uGPU described above to tackle the area concerns with a large chip using a single central xbar. As FIG. 5 shows, the GPU is divided into plural (e.g., two) sub-groups (uGPUs). A central xbar is within each uGPU and the plural uGPUs are connected using point-to-point C2C through LTC slice pairs. In one embodiment, the two uGPUs are fabricated on different dies. These dice are disposed on an interposer along with DRAM memory (e.g., High Bandwidth Memory (HBM) 3D-stacked synchronous dynamic random-access memory (SDRAM)). See for example U.S. Pat. No. 11,609,879. The interposer is disposed within a package that is in turn mounted and connected to a printed circuit board.

There is extra latency to go across the C2C when a GPC in one uGPU wants to access data stored in the other uGPU. The C2C bandwidth and duplication of data in the LTCs (hence reduction of the useful cache capacity) will also impact the overall performance of applications. In the implementation shown, a multi-die solution that enables more DRAM capacity and bandwidth will make the latency over C2C connections even worse across/between uGPUs (although specific embodiments of the technology herein can be advantageously employed to reduce memory access latency over a NOC on a single chip).

Example embodiments can give an alternative to the application to choose between a fully interleaved unified view of memory or localized view per uGPU. The application can choose on uGPU-by-uGPU basis how the virtual uGPU address space gets mapped into the physical DRAM address space. Combining with existing functionality of GPC affinity mask providing GPC localization, applications can put execution and data on the same side of the uGPU so that it can avoid going over the uGPU boundary for shorter latency, higher bandwidth and efficient use of cache capacity.

### Functional Pipeline

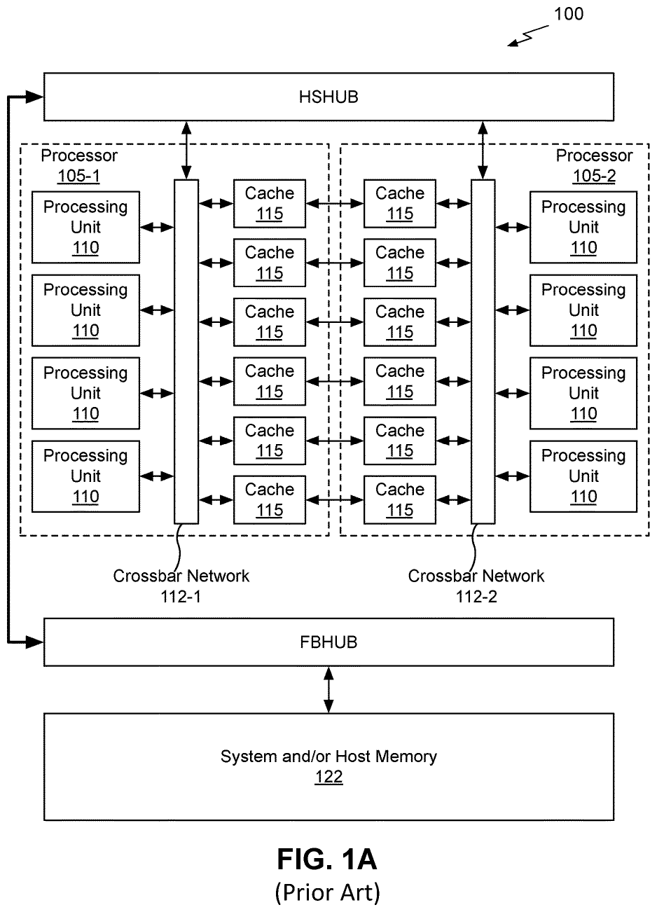

In example embodiments, there are two parts of functionality to enable this memory localization feature:
1) an AMAP address mapping unit (hardware) to provide an additional localized mapping to the uGPU so application data can be localized to a specific uGPU (see FIG. 2 and FIGS. 21-23 of U.S. Pat. No. 11,249,905 and associated description for more information on example MMU AMAPs); and
2) a GPC affinity mask to localize the execution to a GPC belonging to the same uGPU of the data (GPC affinity masks are an existing feature in prior designs).

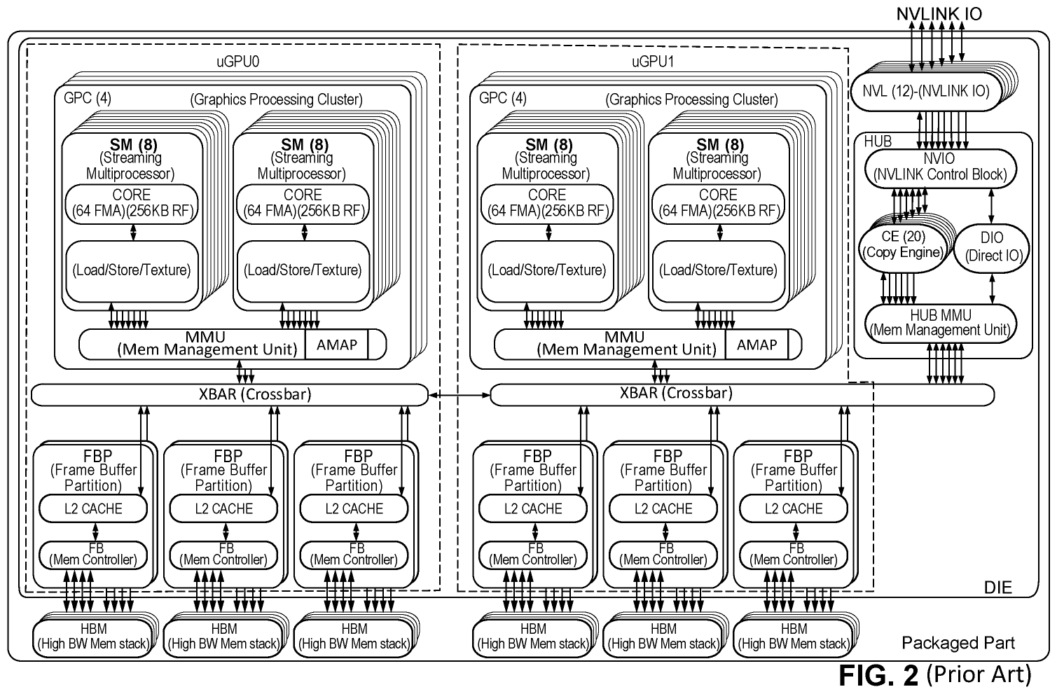

The AMAP change provides two alternative views for the same addressable space of local memory. One view (the traditional view) is a stride view which maps all addresses into all memory units or devices across the full GPU or other multiprocessor address space (see FIG. 3). In this traditional view of memory, linearly increasing the memory address will stride across all of the DRAMs of the GPU memory system, thereby (evenly) distributing data across all of the individual DRAMs making up the memory for the overall GPU. This type of stride access more efficiently utilizes DRAM bandwidth. Such data “striping” is well known in the art-see e.g., U.S. Pat. No. 11,182,309; US20130031328; U.S. Pat. No. 11,249,905. In particular, in one implementation the MMU translates physical addresses into raw addresses associated with DRAM via the AMAP 2110, which may be configured to swizzle addresses across L2 cache slices to avoid situations where striding causes the same L2 cache slice be accessed repeatedly (also known as “camping”).

The other view (which is new in this context) is a localized view which divides or partitions a unit memory space (e.g., 64 MB) into individual plural address spaces associated with the respective plural uGPUs in such a way that the first memory block (e.g., 32 MB) allocation will always go to uGPU0, the second memory block (e.g., 32 MB) allocation will always go to uGPU1, and so on, as shown in FIG. 9B and described in more detail below.

In one example embodiment, an attribute bit is used to select between localized and non-localized memory access. The AMAP within a memory management unit (MMU) of the affected uGPU selects between two alternative mappings places addresses onto the crossbar for accessing the high bandwidth memory system that are either localized/restricted in scope (attribute bit=1) or not localized/restricted in scope (attribute bit=0). Neither the crossbar nor the high bandwidth memory needs to be changed; both may continue to be structured so the complete address space of the high bandwidth memory is accessible by the uGPU. This is a little like a vegetarian voluntarily restricting their order from a full restaurant menu to vegetarian dishes only even though they are given the freedom to order anything they please.

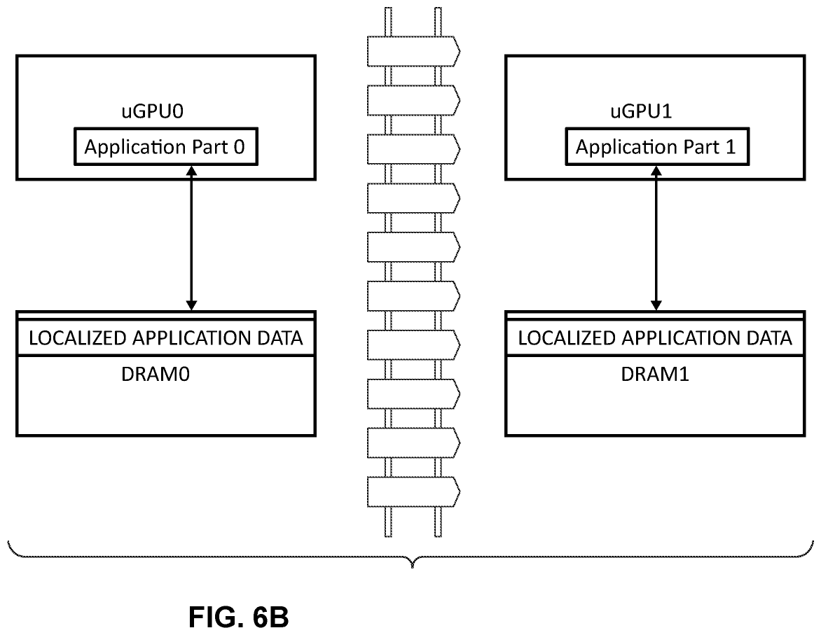

Referring to FIGS. 7 & 8, when the application 102 wants to do uGPU localization, it informs the CUDA driver 104 with the intended uGPU node (e.g., a GPC within a uGPU node) it wants to bind itself to, using the affinity mask (block 1002). When it asks for new allocation under this context, it may set the localization attribute and if it does, the CUDA driver will coordinate with RM 106 to ask the AMAP address mapping hardware to do the localized mapping on multiples of 64 MB aligned memory space (block 1004).

In one embodiment, the RM then sub-allocates the 32 MB halves assigned to the selected uGPU of each 64 MB chunk to the application, as shown in FIG. 9B. In this way, the application gets the memory allocation to the uGPU it binds to.

In more detail, when the address mapping hardware is doing an address translation, it looks at the address mode bit at LOCALIZATION_MODE_BIT_IN_ADDRESS_OFFSET. If it is 0, normal stride mapping is applied (see FIG. 9A). In one embodiment, when the mode bit is not set, the hardware will fine interleave every memory block across the full GPU memory system at a predetermined uGPU stride. Also, in one embodiment, a swizzle may be applied on the uGPU select to avoid camping on commonly-occurring stride address patterns. See FIG. 9A.

When the mode bit is 1, the hardware in one embodiment maps the first block of aligned addresses to uGPU0 and the later (second) block of the aligned addresses to uGPU1. FIG. 9B shows how the addresses are distributed according to the mode bit value. As FIG. 9B shows, when the mode bit is set, all the even first (32 MB in this example) block chunks will be (re)mapped by hardware to uGPUO and all the odd second (32 MB) block chunks will be (re)mapped by hardware to uGPU1 in one embodiment. In one embodiment, there is no swizzling added to the uGPU select in this case, which makes it easy for the software application to find the address to uGPU affinity. Software will be able to look at the physical memory allocation to determine which memory block to access.

From FIGS. 9A, 9B, it can be seen that for any uGPU aligned memory address range up to a certain size (e.g., 64 MB), a different mode will only re-arrange addresses within the memory address range and should not interfere with any addresses in neighboring memory chunks which may be allocated to other uGPUs. This will allow the software application to allocate at e.g., 64 MB granularity and repropose [repurpose?] the mode for any 64 MB chunk without corrupting data of other addresses outside (of the 64 MB). In other words, in one embodiment, each 64 MB block of GPU (DRAM) memory can be mapped using alternate modes (i.e., localized, non-localized) without affecting the mapping of adjacent blocks of GPU memory. This means that different GPU memory blocks can be mapped differently so memory for some uGPUs is mapped as localized whereas memory for other uGPUs is mapped as non-localized. In one embodiment, the mapping will involve the software application using unified mode for all pages within the same aligned 64 MB (or the address can alias).

Referring back to FIG. 7, the next step is when the application launches work; the CUDA driver 104 will use the GPC affinity mask to direct the GPU's central work distributor (CWD) (in the hardware 108) to launch CTAs (bundles of execution threads that execute on the same GPC) to the GPCs belonging to the bound uGPU node (block 1006). Then, when launched CTA threads access memory, the hardware will use the localized memory address mapping to limit the scope of the thread's memory addresses to the DRAM directly connected to the bound uGPU node (block 1008). Combining the data and execution localization, the application can fully achieve localization. Usually, one might expect the application to partition its work into two comparable batches and bind/localize each batch to a different uGPU.

In some embodiments, a smart driver 106 could analyze the application and instruct the hardware 108 to use localized or non-localized memory allocation depending on which allocation mode would be most efficient as indicated by the allocation.

Example Table of GPU Hardware Units Impacted

| Sub-feature | Units impacted |
|---|---|
| AMAP new view of | Memory Management |
| localized mapping | Unit (MMU) |
| Handling localization bit | MMU |
| in FLA | |
| Increase width by 1 bit | XAL (interface unit |
| for localization bit. | between GPU and PCIe |
| | i.e., the CPU) |

### API Changes

In one embodiment, new CUDA APIs are provided for the application to use as noted above.

### Example Functional Description

AMAP video memory mapping is changed to add a new localized mapping. This will impact the memory address mapping hardware within the GPU. One embodiment also selects a higher bit in the MMU page table entry (PTE) address field which will be used to select the mapping mode. RM sets this bit if it wants localized mapping for every 64 MB aligned allocation. Preferably, the same settings of this bit are used across a given 64 MB aligned chunk.

### Per-Unit Functional Contributions

### MMU Functional Contribution

In one example, MMU is changed in two ways:
one mode bit in the address field of PTE indicates which mapping the software application wants: stride (FIG. 9A) or localized (FIG. 9B).
the hardware module that controls the video memory forward mapping that reads the above selected bit is modified to choose stride mapping if it (the mode bit) is 0 and localized mapping if it (the mode bit) is set to 1.

### The Mode Bit

The address field in the PTE is sized for a certain number of bits of addressing for remote memory. One example supported maximum local memory capacity is less than that certain number of bits. So, ample bit positions are available to choose for the uGPU localize mapping mode bit. One embodiment provides a “LOCALIZATION_MODE_BIT_IN_ADDRESS_OFFSET” definition to tell the mode bit location in the address.

### MMU Boundary Checks

Because the localization bit is not an address bit but more like an address attribute, this bit is not an address when doing boundary checks in the MMU.

### Peer NVLink Accesses

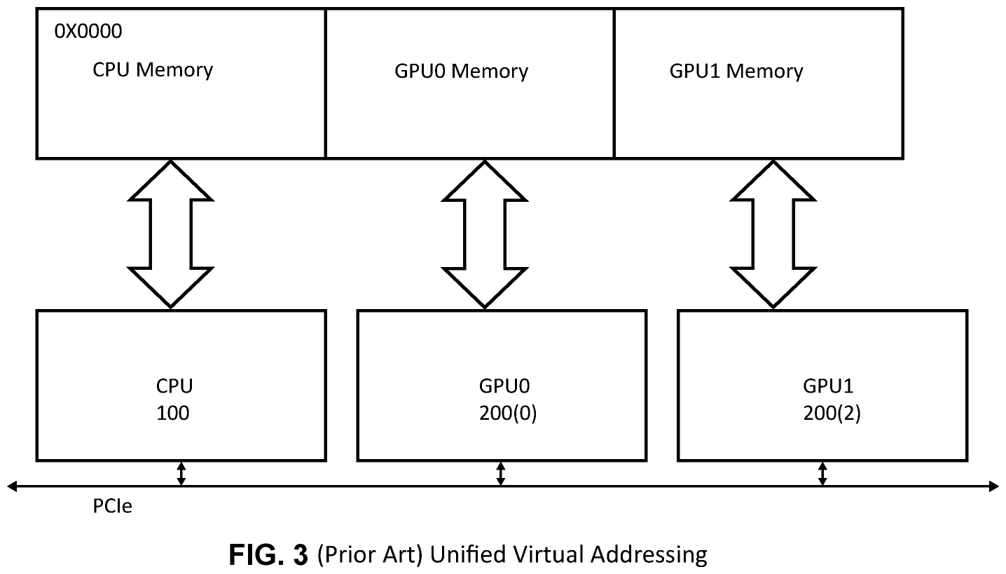

P2P mechanisms supported today in some GPU embodiments such as shown in FIG. 4 comprise guest physical address (GPA) and fabric linear address (FLA) protocols. See e.g., U.S. Pat. Nos. 10,769,076; 11,182,309. Such mechanisms allow one GPU to communicate with one or more other GPUs. For GPA, the page table entry (PTE) mapping is in the source GPU. In some embodiments, it is thus possible to support localization using GPA if there are enough bits in an NVlink packet to carry a localization bit (in such cases, an extended header flit is not required).

Current FLA PTE mapping meanwhile is in the destination GPU in some embodiments and is the same as programming the localization bit for Video memory—so it is possible to use FLA for localized Peer mappings between GPUs.

### Coherent Systems

As discussed above in connection with FIG. 3, in some coherent systems, the operating system (OS) running on the CPU (not the GPU driver) controls the memory allocation for both the CPU and the GPU. See CUDA Programming Guide Section 10 (“Reference Virtual Memory Management.”) To use localization, after allocating a 64 MB chunk from the OS and informing the OS that the memory is “offline” to the OS, RM should set up GMMU mapping using the PTE format. Then all lookup code in RM should be aware of the localization bit in PTE. RM can suballocate from multiple 64 MB chunks returned by OS.

In some embodiments, the CPU cannot access localized memory but it can prefetch localized memory. All GPU memory can be marked as coherently cacheable at boot. When RM gets the 64 MB chunks for localized GMMU mapping. CPU can still prefetch from them—and CPU prefetch in some embodiments has no knowledge of the GPU's memory mapping mode. Therefore, in some such embodiments, unless precautions are taken, the CPU should not prefetch localized memory as the address it thinks is not the address that is actually used within the GPU due to the localized remapping, i.e., the mapping is not as the CPU will expect. In some embodiments, the CPU may prefetch such memory allocations but may not modify them, and the CPU thus does not have any right or privilege over such localized memory. In other embodiments, the localization flag need not be confined to the GPU PTE but could instead be accessible by the CPU operating system-and both the CPU and the GPU can recognize localization and thereby support coherency and shared memory between the GPU and the CPU.

### EXAMPLE

CPU caches data line for GPU LTC x slice y using system physical address (SPA) a. RM gets the 64 MB chunk and makes it localized. Application tries to access the same line in LTC x slice y using localized SPA b. L2 will send prob to CPU. Since the r2p is always doing no-localized reverse mapping, the prob address from the reverse mapping will be a and it will retrieve the correct cached data.

The techniques disclosed herein may be incorporated in any processor that may be used for processing a neural network such as, for example, a central processing unit (CPU), a graphics processing unit (GPU), an intelligence processing unit (IPU), neural processing unit (NPU), tensor processing unit (TPU), neural network processor (NNP), a data processing unit (DPU), a vision processing unit (VPU), an application specific integrated circuit (ASIC), a field-programmable gate array (FPGA), and the like. Such a processor may be incorporated in a personal computer (e.g., a laptop), at a data center, in an Internet of Things (IoT) device, a handheld device (e.g., smartphone), a vehicle, a robot, or any other device that performs inference, training or any other processing of a neural network. Such a processor may be employed in a virtualized system such that an operating system executing in a virtual machine on the system can utilize the processor.

As an example, a processor incorporating the techniques disclosed herein can be employed to process one or more neural networks in a machine to identify, classify, manipulate, handle, operate, modify, or navigate around physical objects in the real world. For example, such a processor may be employed in an autonomous vehicle (e.g., an automobile, motorcycle, helicopter, drone, plane, boat, submarine, delivery robot, etc.) to move the vehicle through the real world. Additionally, such a processor may be employed in a robot at a factory to select components and assemble components into an assembly.

As an example, a processor incorporating the techniques disclosed herein can be employed to process one or more neural networks to identify one or more features in an image or to alter, generate, or compress an image. For example, such a processor may be employed to enhance an image that is rendered using raster, ray-tracing (e.g., using NVIDIA RTX), and/or other rendering techniques. In another example, such a processor may be employed to reduce the amount of image data that is transmitted over a network (e.g., the Internet, a mobile telecommunications network, a WIFI network, as well as any other wired or wireless networking system) from a rendering device to a display device. Such transmissions may be utilized to stream image data from a server or a data center in the cloud to a user device (e.g., a personal computer, video game console, smartphone, other mobile device, etc.) to enhance services that stream images such as NVIDIA Geforce Now (GFN), Google Stadia, and the like.

As an example, a processor incorporating the techniques disclosed herein can be employed to process one or more neural networks for any other types of applications that can take advantage of a neural network. For example, such applications may involve translating from one spoken language to another, identifying and negating sounds in audio, detecting anomalies or defects during production of goods and services, surveillance of living and/or non-living things, medical diagnosis, decision making, and the like.

As an example, a processor incorporating the techniques disclosed herein can be employed to implement neural networks such as large language models (LLMs) to generate content (e.g., images, video, text, essays, audio, and the like), respond to user queries, solve problems in mathematical and other domains, and the like.

All publications including but not limited to patent publications cited herein are incorporated herein by reference as if expressly set forth.

While the preceding is directed to embodiments of the present disclosure, other and further embodiments of the disclosure may be devised without departing from the scope thereof, and the scope of protection is therefore determined by combinations of elements and/or features of the claims that follow.

1. In a GPU based system of the type that uses unified memory addressing to enable multiple processing cores to have a common unified view into memory and access each other's locally connected memory,
GPU address mapping hardware configured to selectively restrict a scope of memory access by an application executing on a processing core to memory locally connected to the processing core.

2. The GPU address mapping hardware of claim 1 wherein the GPU address mapping hardware is further configured to selectively expand the scope of the memory access to striding memory other than the memory that is locally connected to the processing core.

3. The GPU address mapping hardware of claim 1 wherein the GPU address mapping hardware is further configured to selectively restrict the scope of the memory access in response to receipt of a localization attribute from the application.

4. The GPU address mapping hardware of claim 3 wherein the localization attribute comprises a bit or flag, and the GPU address mapping hardware stores the attribute in a page table entry.

5. The GPU address mapping hardware of claim 1 further including a hardware scheduler that selectively restricts execution of the application to the processing core.

6. The GPU address mapping hardware of claim 5 wherein the hardware scheduler selectively restricts execution in response to an affinity mask.

7. The GPU address mapping hardware of claim 1 wherein the GPU based system enables access by the multiple processing cores of each other's locally connected memory via chip-to-chip network connectivity.

8. In a GPU based system of the type that uses unified memory addressing to enable multiple processing cores to have a common unified view into memory and access each other's locally connected memory, a memory access method comprising:
launching execution of an application on a processing core, and
selectively restricting a scope of memory access by the application executing on the processing core to memory that is locally connected to the processing core.

9. The method of claim 8 further including selectively expanding the scope of the memory access to striding memory that is not locally connected to the processing core.

10. The method of claim 8 wherein selectively restricting the scope of the memory access is performed in response to receipt of a localization attribute from the application.

11. The method of claim 10 wherein the localization attribute comprises a bit or flag, and further including storing the attribute in a page table entry.

12. The method of claim 1 further including selectively restricting execution of the application to the processing core.

13. The method of claim 12 wherein the selectively restricting execution is performed in response an affinity mask.

14. The method of claim 1 further including enabling access by the multiple processing cores of each other's locally connected memory via chip-to-chip network connectivity.

15. A graphics processing unit (GPU) comprising:
a first cluster comprising a first processing core,
a first dynamic random access memory (DRAM),
a first crossbar connecting the first cluster to the first DRAM,
a second cluster comprising a second processing core,
a second DRAM,
a second crossbar connecting the second cluster to the second DRAM,
an interconnect between the first and second crossbars configured to enable the first cluster to access the second DRAM and to enable the second cluster to access the first DRAM,
the first cluster further comprising an address mapper connected to the first crossbar, the address mapper being selectively configured to map memory addresses generated by the first cluster so resulting memory accesses are localized to the first DRAM and do not access the second DRAM.

16. The graphics processing unit (GPU) of claim 15 wherein the address mapper is responsive to an attribute that specifies whether memory accesses are to be localized or non-localized.

17. The graphics processing unit (GPU) of claim 15 wherein the first cluster is disposed on a first die, the second cluster is disposed on a second die different from the first die, and the interconnect comprises a chip to chip interconnect.

18. The graphics processing unit (GPU) of claim 15 wherein the first cluster comprises a first micro GPU and the second cluster comprises a second micro GPU.

19. The graphics processing unit (GPU) of claim 15 further including a scheduler that schedules thread blocks for execution on the first cluster or the second cluster based on an affinity mask.

20. The graphics processing unit (GPU) of claim 15 wherein an application executing on the first cluster specifies whether its memory accesses are to be localized to the first DRAM and not access the second DRAM.
